(19) United States
(12) Patent Application Publication
(10) Pub. No.: US 2007/0253640 A1
(43) Pub. Date: Nov. 1, 2007

(54) IMAGE MANIPULATION METHOD AND APPARATUS

(75) Inventor: Stephen David Brett, Swanley Village (GB)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: PANDORA INTERNATIONAL LTD., Greenhithe (GB)

(21) Appl. No.: 11/738,749

(22) Filed: Apr. 23, 2007

(30) Foreign Application Priority Data
Apr. 24, 2006 (GB) 0608069.1

(51) Int. Cl. G06K 9/36

(52) U.S. Cl. 382/276

(57) ABSTRACT

A method of editing a selected area of a digital image which consists of an array of image pixels at a relatively high resolution. The method comprises: dividing the image into a series of discrete tiles at a relatively low resolution, each tile containing a plurality of the image pixels; selecting the image area for editing by generating points on a boundary line of the image area, the points being at a resolution which is higher than the resolution of the tiles; identifying boundary tiles which contain a portion of the boundary line; for each boundary tile, generating data representing a weighting which is dependent on the extent to which that boundary tile contains pixels which are within the selected area and pixels which are outside the selected area; and editing image pixels which are within the selected image area; the editing of pixels which are within a boundary tile being dependent on the weighting associated with that boundary tile.

### FIELD OF THE INVENTION

The present invention relates to a method for image manipulation, and in particular to the selection of areas of a digital image to edit, and applying colour changes to the selected areas.

### BACKGROUND TO THE INVENTION

It is now common to create, process, edit, and complete media in electronic systems. There are many such systems, dating back to electronic page composition systems such as the Crosfield 570 system, manufactured by Crosfield Electronics in the UK from 1975 onwards and the Quantel ‘Paintbox’, manufactured by Quantel Ltd, of Newbury Berkshire, UK since 1981.

These electronic image editing systems are capable of a wide range of effects and processes. Many of these processes are operable preferentially on portions of the image, as usually viewed on Colour Monitors. It is often desirable for the operator to specify which region or object in the image is to be processed, edited, copied, replaced, or altered. Therefore there is a need to allow operators of such equipment a method to specify which part of the picture is to be altered. One common method is to allow the operator to ‘draw’ on a computer tablet, which then ‘echoes’ the shape drawn on the screen with a shape or outline to delineate the image. Obviously in such cases the ‘drawing’ is simulated—in that the operator usually moves an electronic pen over a tablet, which in turn operates software that simulates ‘drawing’ on the monitor.

Many techniques for ‘drawing’ are known, and these techniques have usually been developed to enable ‘cutting out’ of objects or characters from one scene for use in another scene. One common example here is where it is desired to ‘cut out’ a character filmed against one background, and to place this character on a different background. This technique is usually referred to as ‘compositing’. The requirements for this type of operation are to cut with careful delineation between the object being cut out and the background. This is effectively like cutting with a very sharp pair of scissors.

However there are many other reasons for wanting to delineate one region of a picture from another. An example of is to denote an area where it is required to change the colour of the sky from blue to a reddish hue to simulate a sunset in an image, without changing the colour of an automobile in the foreground which is also a similar sky blue. Requirements for this are very different to the character cut out. In the sky example, assume that it is wished to ‘roughly’ delineate the sky region from the car. Indeed, in cases such as these, it is desirable NOT to see a ‘hard’ edge between the two regions (sky and landscape) What is required is to make the top of the picture generally ‘redder’, not affect the car, and not to introduce any artefacts where a ‘join’ in the image appears. Thus this delineation is rather more like a blunt rather than a sharp instrument. Another way of describing the requirement is to use ‘grey’ scissors rather than ‘black and white’ scissors.

A further requirement is that normally it is desired to modify or create not one image, but a motion sequence of many images, that viewed consecutively produce or portray a desired scene. This adds constraints, not only because there are many ‘frames’ in a sequence, but that it is undesirable to have to modify each and every frame in a sequence to accomplish something. Furthermore, it is also undesirable to have large quantities of data to describe a delineation of each and every frame in a sequence, as this creates further demands on storage and delivery systems for digital media.

Typical drawing techniques for compositing involve software implementations to store, process, and implement the ‘drawn’ edges. These systems often store the shape as a series of points that form the edge of the drawn feature, and can contain many tens of thousands of points for high resolution images and complex shapes. To refresh a monitor display under software control to display such a complex edge takes a significant time, and slows down productivity. Also, operators are known to be ‘frustrated’ in having to wait for computers to carry out operations. This frustration can inhibit creative work. It would therefore be advantageous to reduce the amount of data required to be stored to identify an image area of interest.

Known techniques in computer graphics involve an extra ‘channel’ of data, commonly referred to as a ‘key’ channel. This extra plane or channel delineates images that it corresponds to, by in the simplest case having a value ‘1’ at a given pixel co-ordinate to take that value of pixel at those co-ordinates, and a value ‘0’ in a given pixel co-ordinate to not take that value of pixel at those co-ordinates. Often the case may be that if a ‘0’ value exists, there is another image to take a pixel value from at those co-ordinates. Frequently, ‘key’ channels are extended to be not binary (two values) but ‘grey’ (having typically 256 or 1024 values). This ‘grey’ value allows the blending between two image in the proportion or weighting to the grey level. Such systems involve storing and processing considerably more data than just image data—a Grey key signal for a colour image stored in Red, Green, and Blue involves a data expansion of 33% ‘overhead’ to every frame in a sequence.

### SUMMARY OF THE INVENTION

Viewed from a first aspect, the present invention provides a method of editing a selected area of a digital image which consists of an array of image pixels at a relatively high resolution, comprising the steps of:

dividing the image into a series of discrete tiles at a relatively low resolution, each tile containing a plurality of the image pixels;

selecting the image area for editing by generating points on a boundary line of the image area, the points being at a resolution which is higher than the resolution of the tiles;

identifying boundary tiles which contain a portion of the boundary line;

for each boundary tile, generating data representing a weighting which is dependent on the extent to which that boundary tile contains pixels which are within the selected area and pixels which are outside the selected area; and

editing image pixels which are within the selected image area; the editing of pixels which are within a boundary tile being dependent on the weighting associated with that boundary tile.

Thus, for example, consider two adjacent tiles with a grid line between them, and a boundary line which is generally parallel to, and close to, the grid line. The boundary line passes through part of the first tile, then crosses the grid line to extend a short distance into the adjacent second tile, passes parallel to the grid line again, and then crosses back over the grid line into the first tile. In such an arrangement, neither the first tile nor the second tile needs to be treated any different to tiles that are wholly within or wholly outside the selected area. If the first tile is mainly within the selected area, the fact that (a) some pixels within the first tile will be selected for editing in accordance with the same parameters as pixels in tiles which are wholly within the selected area; and (b) some pixels within the second tile will not be selected for editing, even though some are within the selected area, will not have a significant visual effect.

On the other hand, if the boundary line crosses from the first tile into the second by a significant amount, for example towards the centre of the second tile, then the second tile assumes greater significance as a transition tile—i.e. a boundary tile which contains a significant number of pixels which are within the selected area and a significant number of pixels which are outside the selected area. Editing the pixels within the second tile in accordance with the same parameters as those for the main body of tiles within the selected area, or outside the selected area, may not produce an appropriate visual effect. To achieve the appropriate effect it may be necessary for the pixels in the second tile to be edited in accordance with transition parameters. For example if the selected are is blue and the non-selected area is green, the pixels in a transition tile may be edited in accordance with parameters that will provide an intermediate colour.

One way of determining whether a boundary tile is a transition tile which needs to be edited in accordance with transition parameters, is for the weighting to be in accordance with the distance of boundary line points from the centre of a tile. For example, for each boundary line point within a tile, the distance from the centre of the tile can be taken into account. From the individual values an overall parameter can be calculated indicating how close the line is to the centre of the tile. Alternatively, the numbers of pixels in a tile which are within (or outside) the selected area can be determined. If equal numbers are inside and outside the area, then the significance of the tile as a transition tile is at its maximum, and if all or most of the pixels are inside (or outside) the selected area the tile has the lowest significance as a transition tile.

In general, the points generated to represent the boundary line may be at the same resolution as the image pixels, or they could be higher or lower. However, the resolution will be appreciable higher than that of the tiles. As a result, calculations to establish the weighting to be given to a tile have to be carried out on relatively large amounts of data. However, once those calculations have been made, the amount of data that has to be stored to identify which pixels are to be subjected to editing (and if so, in accordance with which parameters) is relatively low, namely determined by the number of tiles and the weighting of each tile—which can for example be 8 bit data or even less if desired.

There may be no explicit identification of transition tiles or indeed of boundary tiles, and all tiles can be given a weighting, with corresponding editing criteria. If, for example, the weighting of tile wholly within the selected area is 255, and the weighting of a tile wholly outside the area is zero, then pixels in zero weighted tiles will not be subjected to any editing at all. Pixels in tiles with weighting 255 will be subjected to the default editing criteria for the selected area. Pixels in tiles with intermediate weightings may be subjected to editing criteria which are dependent on the weighting. There could be a simple choice, with for example weightings in a defined middle range being edited in accordance with a single predetermined transition set of parameters, weightings below that range being treated as if the value was zero and above that range being treated as if the value was 255. Alternatively, there could be a variable range of editing criteria which are dependent on the weighting.

It will be appreciated that the weighting can thus be used not just to indicate the extent to which a tile is a boundary tile, with some pixels inside and some outside the selected area, but also to indicate whether a tile is essentially within or essentially outside the selected area. Thus, for example, weightings 0 to 127 could be used in respect of tiles totally or primarily outside the selected area, with 127 indicating a transition tile which is say 51% outside and 49% inside; and weightings 128 to 255 could be used in respect of tiles totally or primarily inside the selected area, with 128 indicating a transition tile which is say 51% inside and 49% outside. Thus weightings 1 to 254 would indicate transition tiles.

The whole boundary of the image area may be defined in relation to the tiles through which the image area boundary passes. However, it may be preferred in some circumstances to define a portion of the image area boundary using the edge of the image as an implied boundary. This allows the operator to easily select one region of an image by tracking a portion of an image area boundary from edge to edge of the image, and completing the image area boundary using the image edge. The tracked portion is defined in the datastream in relation to the mesh of tiles, and the image edge portion is defined in the datastream as a geometric shape. Further, geometric shapes can be used independently of the image edge to define portions of the image area boundary.

Viewed from a second aspect, the present invention provides a method of manipulating a digital image comprising the steps of:

generating a mesh forming an array of tiles over the image at a resolution lower than the image resolution;

selecting an image area for editing by generating a datastream representing the desired image area boundary, wherein at least a part of the datastream is defined in relation to the tiles through which the boundary passes;

storing the datastream; and

modifying at least one colour in the selected image area.

By defining the image area in terms of the lower resolution of the tile mesh instead of the image resolution, the amount of data in the datastream can be reduced.

In a preferred embodiment, the datastream defined in relation to the tiles is defined by referencing the both value of the tile and the distance from the tile centre. Preferably, the distance from the tile centre is stored as an 8 bit value, where 0 represents an image area boundary at a maximum distance from the tile centre, and 255 represents an image area boundary passing through the tile centre as discussed above.

Viewed from a third aspect, the present invention provides a method of manipulating a digital image comprising the steps of:

generating a mesh forming an array of tiles over the image at a resolution lower than the image resolution, each mesh point having an initial zero modification value;

selecting an image area for editing by generating a datastream representing the desired image area boundary and assigning mesh points within the within the image area a positive modification value;

storing the datastream and the mesh point values; and

modifying at least one colour in the selected image area.

By using the mesh to define the points within the image area, the image area can be more easily edited, and the amount of data required to identify the selected area can be reduced compared to other methods of manipulating images. The positive modification value denotes that modification to the image occurs on pixels of the image associated with that point on the mesh, and no change to the image occurs where the value remains set to zero. The mesh points are the intersections of the lines of the mesh, and thus each tile is associated with four mesh points, one at each corner.

The modification value may be set to full value at all mesh points inside the image area, indicating that maximum change is required at these points. Alternatively, to allow a smoother gradation of the modification applied, the mesh points near the boundary and inside the selected image area may be assigned a partial modification value, which is proportionate to the distance from the boundary, dropping to zero for a point on the boundary.

Modification of a colour in the selected image area may be achieved by assigning each pixel a pixel modification value calculated by interpolating the modification values of the four mesh points surrounding the pixel, and applying a user defined modifier to the pixel in proportion to the pixel modification value. Thus, the final pixel modification value is the multiple of the user defined modifier with the pixel modification value.

Each pixel can therefore be modified appropriately in accordance with its position relative to the image area boundary, and the amount of stored data required to effect this modification is maintained at a minimum.

Preferably, a range of colour is selected for modification by the operator, the digital values of the pixels in the original digital image are looked up, and if the original values are within the selected range the pixel is modified by adding or subtracting the final pixel modification value.

In a preferred embodiment, the modification values of the third aspect and its preferred features are utilised as the weighting data in the first aspect.

In alternative embodiments geometric shapes defined in the datastream may be used to represent all points of the desired image area boundary. These geometric shapes may include shapes associated with the image edge boundary.

Further aspects of the invention provide apparatus arranged to implement the first, second or third aspects of the invention, and computer program products containing instructions for configuring an apparatus to implement the first, second or third aspects of the invention.

For example, viewed from a fourth aspect, the present invention provides a data processing apparatus for editing a selected area of a digital image which consists of an array of image pixels at a relatively high resolution, the data processing apparatus comprising:

means for storing an image and dividing the image into a series of discrete tiles at a relatively low resolution, each tile containing a plurality of the image pixels;

image editing and display means capable of enabling an operator to select the image area for editing by generating points on a boundary line of the image area, the points being at a resolution which is higher than the resolution of the tiles and identifying boundary tiles which contain a portion of the boundary line;

wherein the data processing apparatus is arranged to:

generate data for each boundary tile, the data representing a weighting which is dependent on the extent to which that boundary tile contains pixels which are within the selected area and pixels which are outside the selected area; and

edit image pixels which are within the selected image area; the editing of pixels which are within a boundary tile being dependent on the weighting associated with that boundary tile.

The apparatus or computer program product of the invention may incorporate the features of the preferred embodiments of the methods described above.

### BRIEF DESCRIPTION OF THE DRAWINGS

Preferred embodiments of the present invention will now be described by way of example only and with reference to the accompanying drawings in which:

FIGS. 1a/b show the use of an image edge to define a selected image area,

FIG. 2 shows the closure of an image area boundary using an automatically generated line,

FIG. 3 shows a raster scan of an image to select the interior of a drawn shape,

FIG. 4 shows an overlaid mesh of tiles,

FIG. 5 shows repeat usage of a mesh file on frames of a moving image,

FIG. 6 shows a frame sequence of a moving ball, and

FIG. 7 shows three mesh files being used on the frame sequence of FIG. 6.

### DETAILED DESCRIPTION OF PREFERRED EMBODIMENTS

Typically systems in post production will be required to handle a range of image resolutions. This may include Standard Definition (typically 720 pixels by 576 lines), High Definition (typically 1920 pixels by 1080 lines) and ‘Digital Film’ resolutions of typically 2048 pixels by 1556 lines, although there is a growing trend to operate at the so called ‘4K’ resolution of 4096×3172. It is required to be able to select or delineate an area of an image in these resolutions in order to apply a modification to the image.

In the present invention a ‘mesh’ is laid over the image to be delineated. The overlay mesh can advantageously be of a fixed size, irrelevant of the image resolution Typical mesh resolutions can be 64×64 points. This will effectively divide up a 2K image into image tiles of 32 pixels by 32 lines, and correspondingly smaller image tiles at HD and Standard Definition. The advantage of a fixed size mesh irrespective of image resolution leads to easier hardware implementations of the delineation operation. It is wished to use this sparse set of mesh points only to describe an image or frame delineation, thus saving storage and bandwidth compared with previous systems.

The overlaid mesh forms an array of tiles on the image. When the operator ‘draws’ on the image, which is usually done with a computer peripheral tablet, such as the WACO model Intuous3 A5, he uses a stylus whose position is recognised by the tablet. This gives a stream of ‘pixels’ of the route that the stylus has taken, which provides a high resolution ‘track’ defining the boundary of the selected image area. This is converted to a low resolution track, with each point on the low resolution track representing a tile on the image area boundary. Separately, the distance is calculated from the track to the centre of the tile in question. This value is stored, typically as a scaled 8 bit value, where 0 used for the maximum distance from the tile centre, and 255 is used when the track actually passes through the tile centre. Thus at this point, one can store the results of any drawn track in a data structure of 4096 bytes (32×32×8 bit values). This compares very favourably with data streams of many thousands of points, each with their 10 or 12 bit X and Y co-ordinate addresses. The data stored accurately represents the desired portion of the image area boundary, whilst at the same time ensuring that the size of the data stream is reduced over conventional methods in which co-ordinates based on the image resolution, ‘bit plane’ or ‘Key Channel’ systems are used.

As discussed above, the 8 bit values can then be used to provide weighting data dependent on the extent to which that boundary tile contains pixels which are within the selected area and pixels which are outside the selected area, and this weighting data can be used when editing the image.

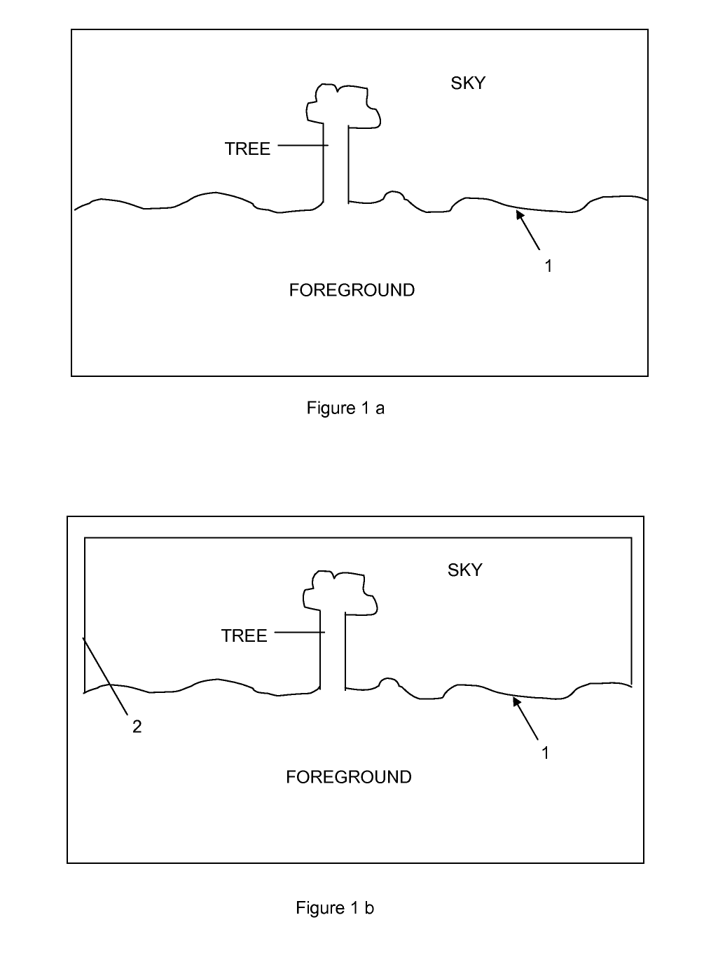

A further enhancement can be to use the image boundary as an implied boundary to the lines drawn. For example, if an operator draws across the horizon in a scene, one can infer that what he wants is to designate that there are two regions, land and sky. As shown in FIG. 1, a track 1 is drawn identifying part of the image area boundary as the horizon line. The selected image area is then completed by defining geometric shapes using the image boundaries 2.

Yet another way of ‘drawing’ can be to utilise a series of geometric ‘primitives’ such as squares, triangles, rectangles, circles, and ellipses. In this mode, the operator can select a primitive shape object, position it on the screen, resize as necessary, and further combine other primitives to make a desired composite shape.

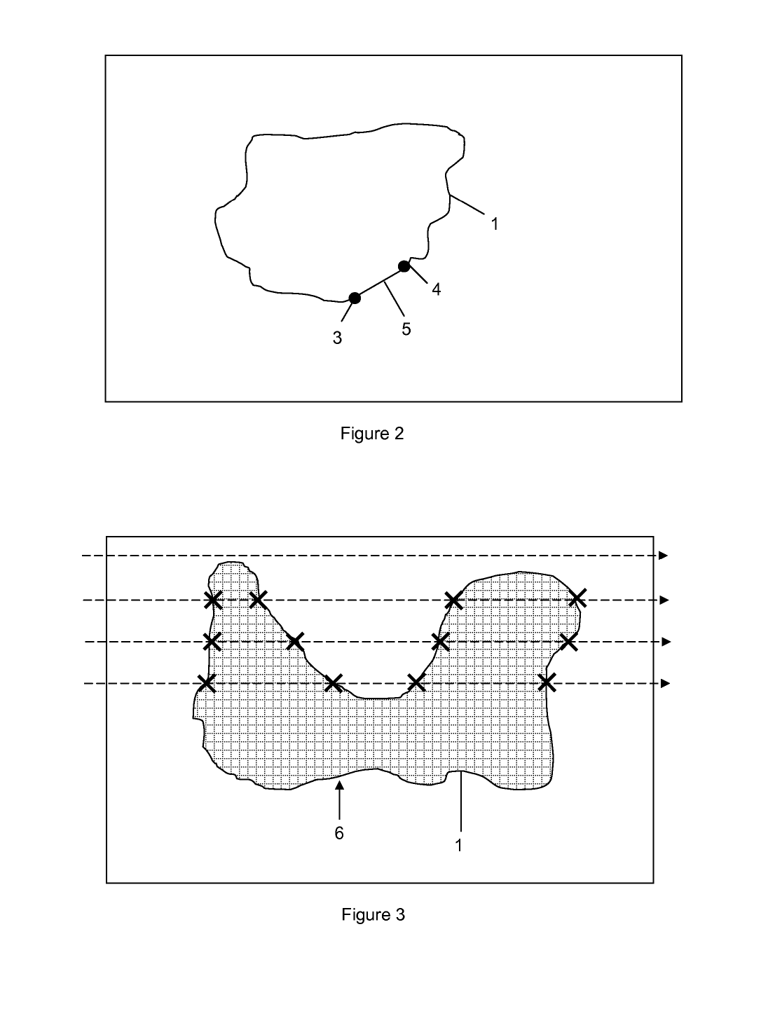

It is then necessary to ‘close’ the shape drawn. One method of ‘closing’ a shape is for an operator to press or enter a special function key or command, which then connects the start of the operator's drawn line to the end. This is illustrated in FIG. 2. A track 1 has a start point 3 and an end point 4. The start point 3 and the end point 4 are connected by a straight line 5. Another method is to have an automatic detection system, that if the final pen plot points within a certain small minimum value of the starting point, the connection of the start and end of the drawn line can automatically be completed.

Now, to separate one part of the image from another using the image area boundary 1 obtained, one needs to ‘fill’ the drawn shape 6. The simplest method for filling is to raster scan through the image to detect state changes at lines. For example if it is assumed that in the top left hand corner of an image one is ‘outside’ a shape, then when one encounters and crosses a line, it is known that all values on the other side of this line are in a different state, which shall be referred to as ‘inside’. This will continue again until the line is crossed again, in which case the state will revert to ‘outside’ again. This is shown in FIG. 3. Other known ‘fill’ algorithms propagate from an operator entered point in as many directions as they can without crossing lines. This also serves to distinguish between the two image states.

When the above is complete, the modification value of all mesh points within or ‘inside’ the shape should be altered. This could be done by setting all points ‘inside’ to be the ‘full’ value. Alternatively, points near the boundary of the selected area could have a partial modification value. This means that one wants maximum change to the image on the inside part of the shape, a partial change proportional to how close to the line one is around the edge, and no effect outside the drawn shape. The 8 bit weighting values can also be utilised to determine modification values.

To display the effect of the delineation, it is now necessary to select a colour to change, and specify that change. This may be from numerically entered parameters, from a colour ‘palette’ or preferentially, the operator will choose the mode of colour selection, and use the computer stylus and tablet to ‘pick’ a colour. He will do this by looking at the computer monitor, and moving the displayed ‘cursor’ to the relevant part of the image. When the cursor is over the relevant part of the image, the operator will confirm that this is the correct part, either by pressing down on the stylus, or depressing an ‘enter’ key on the console. This entry will cause the control computing logic to calculate an average of the R, G and B values for a tile under the cursor. This tile size is operator selectable, and will typically be 4×4 pixels/lines or 8×8 pixels/lines. One way of implementing a change in the tile size of colour specification is to enable the operator to draw tight clockwise circles around the region using the stylus to increase the tile size, and tight anti-clockwise circles around the point to decrease the tile size.

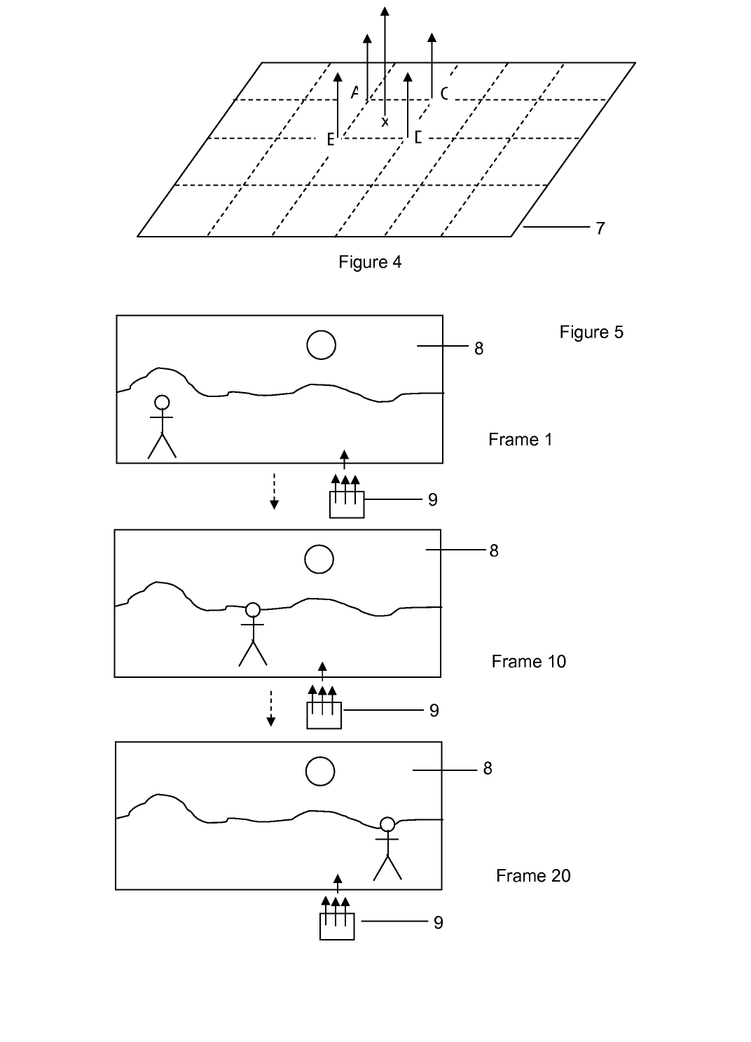

The next step is to apply the colour change to the shape drawn. One looks at picture elements in the scene, and decide whether they fall within a selected range around the entered colour (for example a range of sky blues). This is done by looking up the digital values of each and every pixel in the original high resolution image, and if it is within the selected range of colour, calculating a modifier to those values. This modifier is calculated by using the corresponding co-ordinate point in the mesh grid, and by two dimensionally interpolating the mesh point modification values to derive a modification value for the pixel at that point. This process is shown in FIG. 4. An image mesh 7 contains the co-ordinate point of interest X, which is in a tile having at its corners mesh points A, B, C and D. The mesh points have modification values indicated by the upward arrows. The modification value for the point X is derived by interpolating the values of the four neighbouring mesh points in two dimensions.

The modification value is then multiplied by the modification specified by the operator, to derive the modification for that picture element. This modification is added or subtracted to the original pixel values to produce the new pixel value. By way of example, consider points well outside the drawn shape. At these points, the mesh points will be zero, and the derived alteration value will be zero. The modification signal will then be zero, and no alteration to the original pixel will take place.

Thus the method provides a way of specifying the delineation of an image, using only a minimal data set, using only 4096 values, which can work with very high resolution imagery. Moreover, the visual results produced by such a system are very pleasing to the eye, as they contain no visual discontinuities due to the smoothing effect of the partial modification values at the boundary, and the interpolation of the mesh point values to the pixel modification values.

To implement such a system, it is preferable to use an industry standard Personal Computer (PC) to perform the drawing software, and to produce the sparse mesh data set. To implement the data set in ‘real time’ as images are viewed, it is desirable to perform the necessary steps in hardware, preferably assembled using FPGA components from companies such as Xilinx. This architecture gives the balance of carrying out the non-real time part of the process (drawing and operator control) in software, which is readily changeable, and the ‘real time’ part of the process, actually implementing the required colour changes on a sequence of images in hardware, which is particularly cost effective for the performance obtained.

Further enhancements to the above system can be made utilising the fact that it is a motion sequence of images that is required to be processed. In simple cases, one may have a stationary camera, looking at an outdoor scene with a horizon. This is illustrated in FIG. 5, which shows frames 1, 10 and 20 of a 20 frame sequence in which the background remains fixed, and a character moves across the foreground. One may wish to alter the sky 8 in this sequence. In this case, one only needs to isolate the sky 8 once, and obtain a suitable mesh data file 9. This mesh data 9 provides an alteration map that can be used for every frame in this sequence.

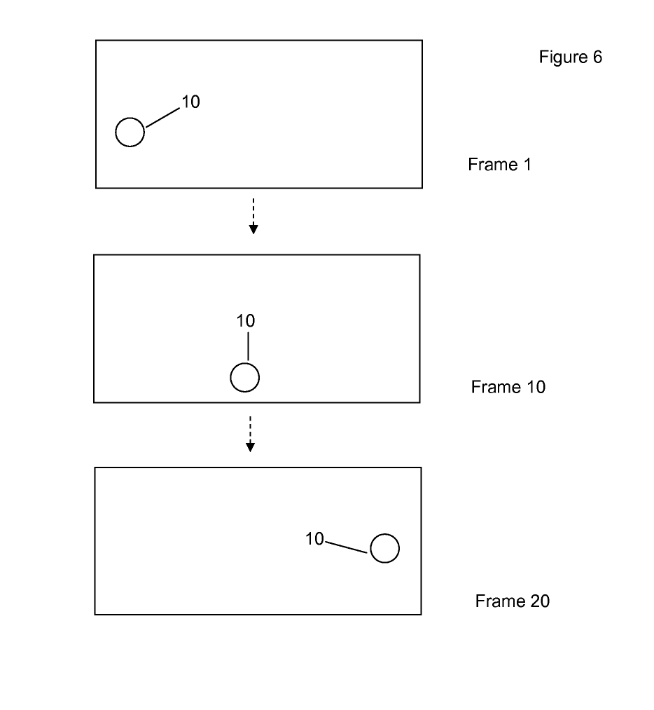

Obviously much more complex cases exist. Consider a scene where the camera is stationary, but a red ball is thrown across the scene over a number of frames. This is indicated in FIG. 6, which shows the ball 10 in frames 1, 10 and 20 of a 20 frame sequence. For this case there are several implementations that can be carried out, depending on the time available and the quality required. The most thorough case is for the operator to draw round the ball 10 on every frame. Thus, using the process described above, a mesh data file can be produced for every frame. This will give the highest quality.

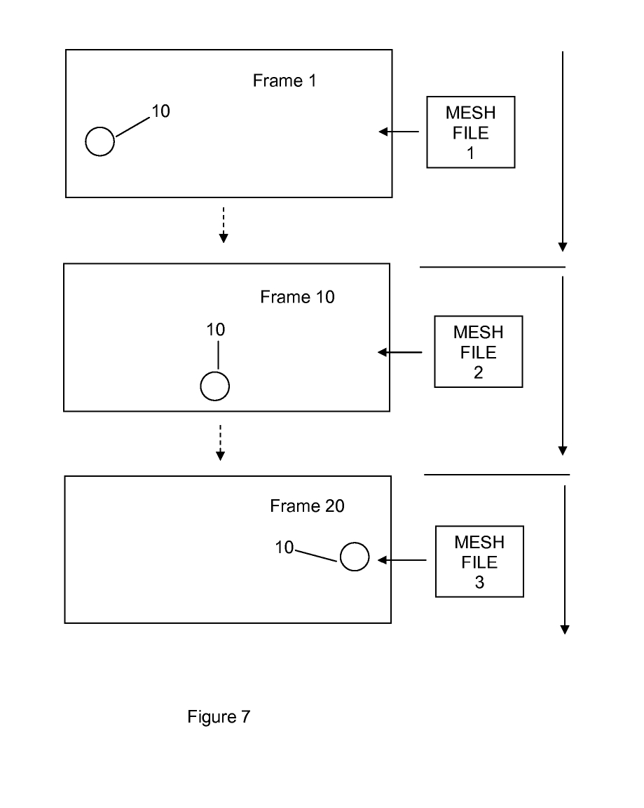

One can also decide to just select a larger area of image around the ball 10 in the first, middle, and last frames of the sequence. This will give three distinct mesh data files, which can be used as shown in FIG. 7. Because one is not ‘cutting out’ the red ball 10, but just specifying an area in which to make the red ball 10 redder, the boundaries do not need to be precise. If one attempts to process the blue sky in the background, the colour correction process will recognise that the blue sky isn't red to start with, and therefore won't attempt to make it redder. Thus the outline need only to delineate between the red ball 10 in the sky and, for example, an equally red car in another part of the frame. Thus, it has been found that most of the time it is not necessary to have unique mesh data files for each frame. A further variant is to modify a mesh data file, either by interpolating between original mesh data files, or applying a positional offset to the mesh data file that corresponds to the movement of (in this case) the ball 10 between the frame that the actual real mesh data file was created and the frame for which it was wished to produce a modified file for.

In summary, there has been described a two stage process, split between a software task and dedicated hardware, that allows the decomposition of digital images and motion sequences into regions for differential processing. This process works with a minimal data set by using mesh data to define an image area boundary and/or modification values for points within the image area, thus optimising storage and communications bandwidths. Further, the formulation of this minimal data set produces more realistic and natural changes to images than would be obtained conventionally with significantly larger delineation files due to the smoothing effect of the interpolation of values and the possibility of partial modification values for mesh points in proximity to the boundary.

What is claimed is:

1. A method of editing a selected area of a digital image which consists of an array of image pixels at a relatively high resolution, comprising:
dividing the image into a series of discrete tiles at a relatively low resolution, each tile containing a plurality of the image pixels;
selecting the image area for editing by generating points on a boundary line of the image area, the points being at a resolution which is higher than the resolution of the tiles;
identifying boundary tiles which contain a portion of the boundary line;
for each boundary tile, generating data representing a weighting which is dependent on the extent to which that boundary tile contains pixels which are within the selected area and pixels which are outside the selected area; and
editing image pixels which are within the selected image area; the editing of pixels which are within a boundary tile being dependent on the weighting associated with that boundary tile.

2. A method as claimed in claim 1, wherein the weighting is based on the distance of the boundary line points from the centre of the tile.

3. A method as claimed in claim 2, wherein for each boundary line point within a tile, the distance of the boundary line point from the centre of the tile is assessed and a parameter is calculated indicating how close the line is to the centre of the tile.

4. A method as claimed in claim 1, wherein the weighting is based on the number of pixels in a tile which are within the selected area.

5. A method as claimed in claim 1, wherein the weighting is in a range such that a tile fully within the selected area would have a weighting at one end of the range, a tile fully outside the area would have a weighting at the other end of the range, and thus boundary tiles have a value in the range between the end points.

6. A method as claimed in claim 1, wherein the boundary of the image area is defined at least in part, by the edge of the image or by geometric shapes.

7. A data processing apparatus for editing a selected area of a digital image which consists of an array of image pixels at a relatively high resolution, the data processing apparatus comprising:
a data storage and processing device for storing an image and dividing the image into a series of discrete tiles at a relatively low resolution, each tile containing a plurality of the image pixels;
an image editing and display device capable of enabling an operator to select the image area for editing by generating points on a boundary line of the image area, the points being at a resolution which is higher than the resolution of the tiles and identifying boundary tiles which contain a portion of the boundary line;
wherein the data processing apparatus is arranged to:
generate data for each boundary tile, the data representing a weighting which is dependent on the extent to which that boundary tile contains pixels which are within the selected area and pixels which are outside the selected area; and
edit image pixels which are within the selected image area; the editing of pixels which are within a boundary tile being dependent on the weighting associated with that boundary tile.

8. A method of manipulating a digital image comprising:
generating a mesh forming an array of tiles over the image at a resolution lower than the image resolution;
selecting an image area for editing by generating a datastream representing the desired image area boundary, wherein at least a part of the datastream is defined in relation to the tiles through which the boundary passes;
storing the datastream; and
modifying at least one colour in the selected image area.

9. A method as claimed in claim 8, wherein the datastream defined in relation to the tiles is defined by referencing the both value of the tile and the distance of the image area boundary from the tile centre.

10. A data processing apparatus for manipulating a digital image comprising:
a mesh generating device for generating a mesh forming an array of tiles over the image at a resolution lower than the image resolution;
an image area selecting device for selecting an image area for editing by generating a datastream representing the desired image area boundary, wherein at least a part of the datastream is defined in relation to the tiles through which the boundary passes;
a data storage means for storing the datastream; and
a colour modification device for modifying at least one colour in the selected image area.

11. A method of manipulating a digital image comprising:
generating a mesh forming an array of tiles over the image at a resolution lower than the image resolution, each mesh point having an initial zero modification value;
selecting an image area for editing by generating a datastream representing the desired image area boundary and assigning mesh points within the within the image area a positive modification value;
storing the datastream and the mesh point values; and
modifying at least one colour in the selected image area.

12. A method as claimed in claim 11, wherein the modification value is set to a maximum value at all mesh points inside the image area, indicating that maximum change is required at these points.

13. A method as claimed in claim 11, wherein mesh points near the boundary and inside the selected image area are assigned a partial modification value, which is proportionate to the distance from the boundary and drops to zero for a point on the boundary.

14. A method as claimed in claim 11, wherein modification of a colour in the selected image area is achieved by assigning each pixel a pixel modification value calculated by interpolating the modification values of the four mesh points surrounding the pixel, and applying a user defined modifier to the pixel in proportion to the pixel modification value.

15. A method as claimed in claim 14, wherein a range of colour is selected for modification by the operator, the digital values of the pixels in the original digital image are looked up, and if the original values are within the selected range the pixel is modified by adding or subtracting the final pixel modification value.

16. A method as claimed in claim 1, wherein the modification values of claim 11 are utilised as the weighting data.

17. A data processing apparatus for manipulating a digital image comprising:
a mesh generator for generating a mesh forming an array of tiles over the image at a resolution lower than the image resolution, each mesh point having an initial zero modification value;
an image area selection device for selecting an image area for editing by generating a datastream representing the desired image area boundary and assigning mesh points within the within the image area a positive modification value;
a data storage device for storing the datastream and the mesh point values; and
a colour modification device for modifying at least one colour in the selected image area.

18. An apparatus as claimed in claim 17, wherein the colour modification device is arranged to calculate a pixel modification value for each pixel by interpolating the modification values of the four mesh points surrounding the pixel, and apply a user defined modifier to the pixel in proportion to the pixel modification value.

19. A method as claimed in claim 17, wherein the colour modification device is arranged to look up the digital values of the pixels in the original digital image, compare these values with a range of colour is selected for modification by the operator, and if the original digital values are within the selected range to modify the pixel by adding or subtracting the final pixel modification value.

20. A computer program product comprising instructions which when executed on data processing apparatus will configure the data processing apparatus to carry out a method of editing a selected area of a digital image which consists of an array of image pixels at a relatively high resolution, said method comprising:
dividing the image into a series of discrete tiles at a relatively low resolution, each tile containing a plurality of the image pixels;
selecting the image area for editing by generating points on a boundary line of the image area, the points being at a resolution which is higher than the resolution of the tiles;
identifying boundary tiles which contain a portion of the boundary line;
for each boundary tile, generating data representing a weighting which is dependent on the extent to which that boundary tile contains pixels which are within the selected area and pixels which are outside the selected area; and
editing image pixels which are within the selected image area; the editing of pixels which are within a boundary tile being dependent on the weighting associated with that boundary tile.

21. A computer program product comprising instructions which when executed on data processing apparatus will configure the data processing apparatus to carry out a method of manipulating a digital image comprising:
generating a mesh forming an array of tiles over the image at a resolution lower than the image resolution;
selecting an image area for editing by generating a datastream representing the desired image area boundary, wherein at least a part of the datastream is defined in relation to the tiles through which the boundary passes;
storing the datastream; and
modifying at least one colour in the selected image area.

22. A computer program product comprising instructions which when executed on data processing apparatus will configure the data processing apparatus to carry out a method of manipulating a digital image comprising:
generating a mesh forming an array of tiles over the image at a resolution lower than the image resolution, each mesh point having an initial zero modification value;
selecting an image area for editing by generating a datastream representing the desired image area boundary and assigning mesh points within the within the image area a positive modification value;
storing the datastream and the mesh point values; and
modifying at least one colour in the selected image area.
